(19) United States
(12) Patent Application Publication
(10) Pub. No.: US 2014/0351186 A1
(43) Pub. Date: Nov. 27, 2014

(54) SPIKE TIME WINDOWING FOR IMPLEMENTING SPIKE-TIMING DEPENDENT PLASTICITY (STDP)

(71) Applicant: QUALCOMM Incorporated, San Diego, CA (US)

(72) Inventors: David Jonathan JULIAN, San Diego, CA (US); Jeffrey Alexander LEVIN, San Diego, CA (US); Kristopher PETERSON, San Diego, CA (US); Ravindra Manohar PATWARDHAN, San Diego, CA (US)

(73) Assignee: QUALCOMM Incorporated, San Diego, CA (US)

(21) Appl. No.: 14/084,302

(22) Filed: Nov. 19, 2013

Related U.S. Application Data
(60) Provisional application No. 61/825,657, filed on May 21, 2013.
(60) Provisional application No. 61/862,714, filed on Aug. 6, 2013.

(51) Int. Cl. G06N 3/08

(52) U.S. Cl. CPC G06N 3/08
USPC 706/20

(57) ABSTRACT

Methods and apparatus are provided for implementing spike-timing dependent plasticity (STDP) using windowing of spikes. One example method for operating an artificial nervous system generally includes recording spike times for a first artificial neuron, recording spike times for a second artificial neuron coupled to the first artificial neuron via a synapse, processing spikes for the second artificial neuron according to a window based at least in part on the spike times for the first artificial neuron, and updating a parameter (e.g., a weight or a delay) of the synapse based on the processing.

### CLAIM OF PRIORITY UNDER 35 U.S.C. §119

This application claims benefit of U.S. Provisional Patent Application Ser. No. 61/825,657, filed May 21, 2013 and entitled “Spike Time Windowing for Implementing Spike-Timing Dependent Plasticity (STDP),” and U.S. Provisional Patent Application Ser. No. 61/862,714, filed Aug. 6, 2013 and entitled “Spike Time Windowing for Implementing Spike-Timing Dependent Plasticity (STDP),” each of which is herein incorporated by reference in its entirety.

### BACKGROUND

1. Field

Certain aspects of the present disclosure generally relate to artificial nervous systems and, more particularly, to implementing spike-timing dependent plasticity (STDP) using windowing of spike times.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure generally relate to implementing spike-timing dependent plasticity (STDP) using windowing of spike times.

Certain aspects of the present disclosure provide a method for operating an artificial nervous system. The method generally includes recording spike times for a first artificial neuron, recording spike times for a second artificial neuron coupled to the first artificial neuron via a synapse, processing spikes for the second artificial neuron according to a window based at least in part on the spike times for the first artificial neuron, and updating a parameter of the synapse based on the processing.

Certain aspects of the present disclosure provide an apparatus for operating an artificial nervous system. The apparatus generally includes a processing system and a memory coupled to the processing system. The processing system is typically configured to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing.

Certain aspects of the present disclosure provide an apparatus for operating an artificial nervous system. The apparatus generally includes means for recording spike times for a first artificial neuron, means for recording spike times for a second artificial neuron coupled to the first artificial neuron via a synapse, means for processing spikes for the second artificial neuron according to a window based at least in part on the spike times for the first artificial neuron, and means for updating a parameter of the synapse based on the processing.

Certain aspects of the present disclosure provide a computer program product for operating an artificial nervous system. The computer program product generally includes a computer-readable medium having instructions executable to record spike times for a first artificial neuron; to record spike times for a second artificial neuron coupled to the first artificial neuron via a synapse; to process spikes for the second artificial neuron according to a window based at least in part on the spike times for the first artificial neuron; and to update a parameter of the synapse based on the processing.

Certain aspects of the present disclosure provide a method for operating an artificial nervous system. The method generally includes recording spike times for a first artificial neuron, recording spike times for a second artificial neuron coupled to the first artificial neuron via a synapse, processing spikes for the second artificial neuron according to a window based at least in part on the spike times for the first artificial neuron, and updating a parameter of the synapse based on the processing. Recording the spike times for the second artificial neuron typically includes keeping the spike times for the second artificial neuron that occur within a predetermined amount of time; and ignoring or discarding any spike times for the second artificial neuron in the window, but outside the predetermined amount of time.

Certain aspects of the present disclosure provide a method for operating an artificial nervous system. The method generally includes recording spike times for a first artificial neuron, recording spike times for a second artificial neuron coupled to the first artificial neuron via a synapse, processing spikes for the second artificial neuron according to a window based at least in part on the spike times for the first artificial neuron, and updating a parameter of the synapse based on the processing. Recording the spike times for the second artificial neuron typically includes keeping up to a predetermined number of the spike times for the second artificial neuron; and ignoring or discarding any spike times for the second artificial neuron above the predetermined number.

Certain aspects of the present disclosure provide an apparatus for operating an artificial nervous system. The apparatus generally includes a processing system and a memory coupled to the processing system. The processing system is typically configured to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing. The processing system is typically configured to record the spike times for the second artificial neuron by keeping the spike times for the second artificial neuron that occur within a predetermined amount of time; and ignoring or discarding any spike times for the second artificial neuron in the window, but outside the predetermined amount of time.

Certain aspects of the present disclosure provide an apparatus for operating an artificial nervous system. The apparatus generally includes a processing system and a memory coupled to the processing system. The processing system is typically configured to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing. The processing system is typically configured to record the spike times for the second artificial neuron by keeping up to a predetermined number of the spike times for the second artificial neuron; and ignoring or discarding any spike times for the second artificial neuron above the predetermined number.

Certain aspects of the present disclosure provide an apparatus for operating an artificial nervous system. The apparatus generally includes means for recording spike times for a first artificial neuron, means for recording spike times for a second artificial neuron coupled to the first artificial neuron via a synapse, means for processing spikes for the second artificial neuron according to a window based at least in part on the spike times for the first artificial neuron, and means for updating a parameter of the synapse based on the processing. The means for recording the spike times for the second artificial neuron is typically configured to keep the spike times for the second artificial neuron that occur within a predetermined amount of time and to ignore or discard any spike times for the second artificial neuron in the window, but outside the predetermined amount of time.

Certain aspects of the present disclosure provide an apparatus for operating an artificial nervous system. The apparatus generally includes means for recording spike times for a first artificial neuron, means for recording spike times for a second artificial neuron coupled to the first artificial neuron via a synapse, means for processing spikes for the second artificial neuron according to a window based at least in part on the spike times for the first artificial neuron, and means for updating a parameter of the synapse based on the processing. The means for recording the spike times for the second artificial neuron is configured to keep up to a predetermined number of the spike times for the second artificial neuron and to ignore or discard any spike times for the second artificial neuron above the predetermined number.

Certain aspects of the present disclosure provide a computer program product for operating an artificial nervous system. The computer program product generally includes a computer-readable medium having instructions executable to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing. Recording the spike times for the second artificial neuron typically includes keeping the spike times for the second artificial neuron that occur within a predetermined amount of time; and ignoring or discarding any spike times for the second artificial neuron in the window, but outside the predetermined amount of time.

Certain aspects of the present disclosure provide a computer program product for operating an artificial nervous system. The computer program product generally includes a computer-readable medium having instructions executable to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing. Recording the spike times for the second artificial neuron typically includes keeping up to a predetermined number of the spike times for the second artificial neuron; and ignoring or discarding any spike times for the second artificial neuron above the predetermined number.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 illustrates an example processing unit (neuron) of a computational network (neural system or neural network), in accordance with certain aspects of the present disclosure.

FIG. 3 illustrates an example spike-timing dependent plasticity (STDP) curve in accordance with certain aspects of the present disclosure.

FIG. 4 is an example graph of state for an artificial neuron, illustrating a positive regime and a negative regime for defining behavior of the neuron, in accordance with certain aspects of the present disclosure.

FIG. 5 is an example double exponential STDP curve with parameter values, in accordance with certain aspects of the present disclosure.

FIGS. 6A, 6B, and 7 illustrate example windows based on pre-synaptic spike times for processing post-synaptic spikes, in accordance with certain aspects of the present disclosure.

FIG. 8 is a flow diagram of example operations for updating STDP for each pre-synaptic spike, in accordance with certain aspects of the present disclosure.

FIG. 9 illustrates long-term potentiation (LTP) and long-term depression (LTD) associations based on the example window of FIG. 6A, in accordance with certain aspects of the present disclosure.

FIG. 10 illustrates counting post-synaptic spikes between pre-synaptic spikes, in accordance with certain aspects of the present disclosure.

FIG. 11 is a flow diagram of example operations for operating an artificial nervous system, in accordance with certain aspects of the present disclosure.

FIG. 11A illustrates example means capable of performing the operations shown in FIG. 11.

FIG. 12 is a block diagram of an example hardware implementation for two artificial neurons and the associated synaptic connection, in accordance with certain aspects of the present disclosure.

FIG. 13 is a block diagram of an example hardware implementation for an artificial nervous system, in accordance with certain aspects of the present disclosure.

FIG. 14 illustrates an example implementation for operating an artificial nervous system using a general-purpose processor, in accordance with certain aspects of the present disclosure.

FIG. 15 illustrates an example implementation for operating an artificial nervous system where a memory may be interfaced with individual distributed processing units, in accordance with certain aspects of the present disclosure.

FIG. 16 illustrates an example implementation for operating an artificial nervous system based on distributed memories and distributed processing units, in accordance with certain aspects of the present disclosure.

FIG. 17 illustrates an example implementation of a neural network in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

### An Example Neural System

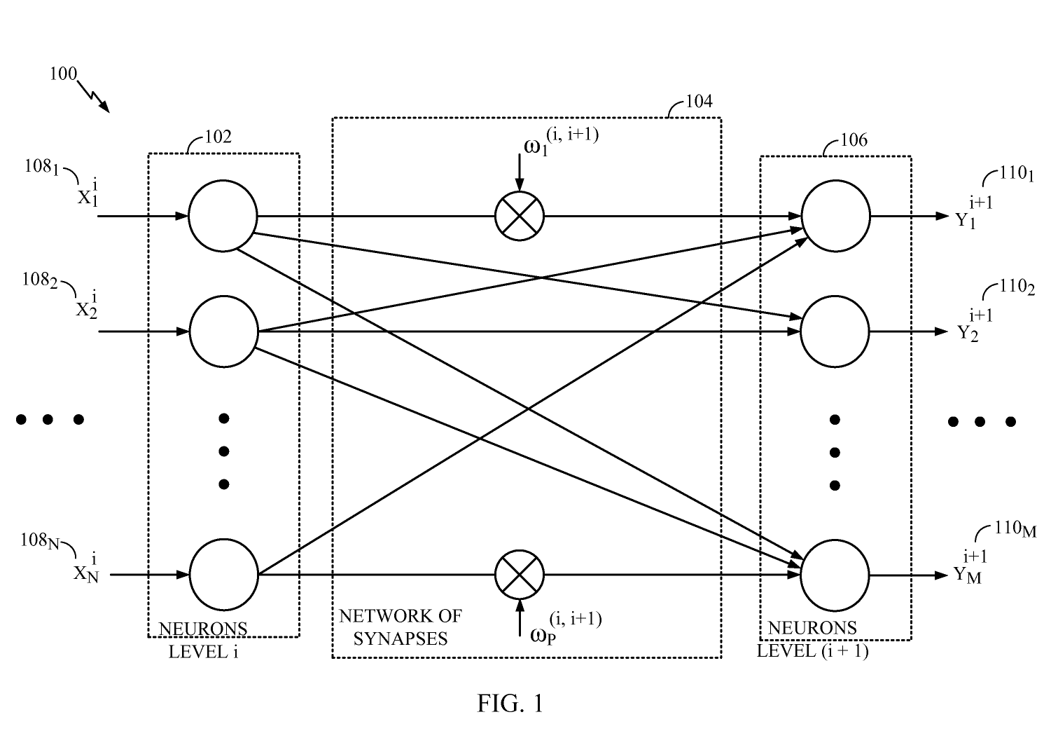

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input (e.g., an input current) to the level 102 neuron. Such inputs may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all-or nothing nerve impulse, having an amplitude of roughly 100 mV and a duration of about 1 ms. In a particular aspect of a neural system having a series of connected neurons (e.g., the transfer of spikes from one level of neurons to another in FIG. 1), every action potential has basically the same amplitude and duration, and thus, the information in the signal is represented only by the frequency and number of spikes (or the time of spikes), not by the amplitude. The information carried by an action potential is determined by the spike, the neuron that spiked, and the time of the spike relative to one or more other spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104). For certain aspects, these signals may be scaled according to adjustable synaptic weights w₁^{(i,i+1)}, . . . , w_{P}^{(i,i+1)} (where P is a total number of synaptic connections between the neurons of levels 102 and 106). For other aspects, the synapses 104 may not apply any synaptic weights. Further, the (scaled) signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example, due to its dynamics or feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and the like. Each neuron (or neuron model) in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

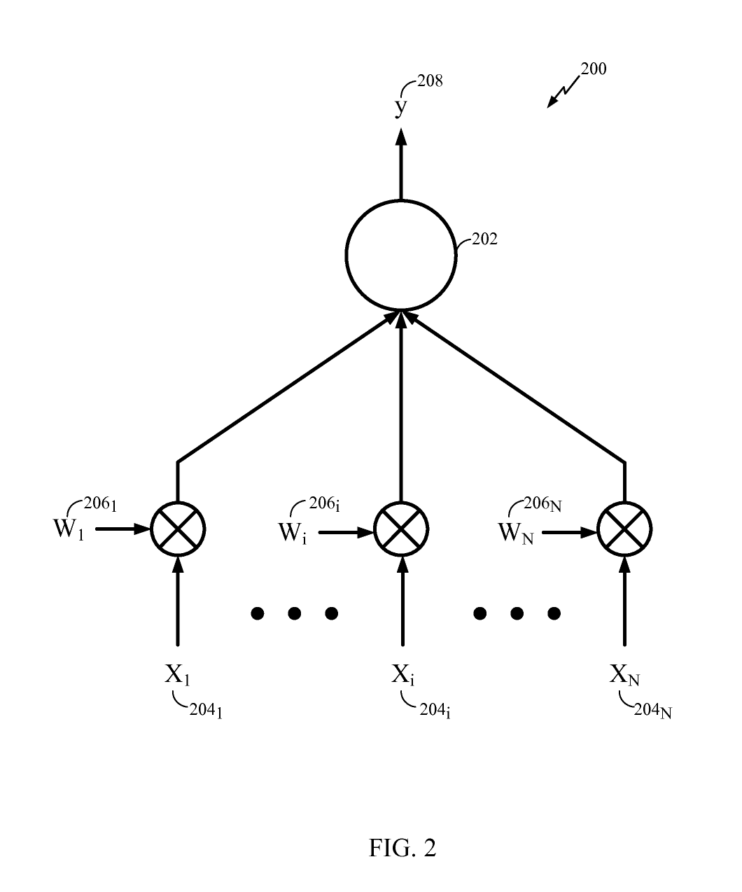

FIG. 2 illustrates an example 200 of a processing unit (e.g., an artificial neuron 202) of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 2061-206N (w₁-w_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron 202) may be emulated by an electrical circuit, and its input and output connections may be emulated by wires with synaptic circuits. The processing unit, its input and output connections may also be emulated by a software code. The processing unit may also be emulated by an electric circuit, whereas its input and output connections may be emulated by a software code. In an aspect, the processing unit in the computational network may comprise an analog electrical circuit. In another aspect, the processing unit may comprise a digital electrical circuit. In yet another aspect, the processing unit may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate in together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synaptic delay may change only when a weight change occurs or if weights reach zero, but not if the weights are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as to computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity, and homeostatic plasticity.

STDP is a learning process that adjusts the strength of synaptic connections between neurons, such as those in the brain. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. In contrast, long-term depression (LTD) may occur if an input spike tends, on average, to occur immediately after an output spike. Then, that particular input is made somewhat weaker, hence the name “spike-timing-dependent plasticity.” Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period (i.e., being sufficiently cumulative to cause the output), the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₐᵣₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , & t > 0 \\ {a}_{-} {e}^{t / {k}_{-}} , & t < 0\end{matrix} , \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

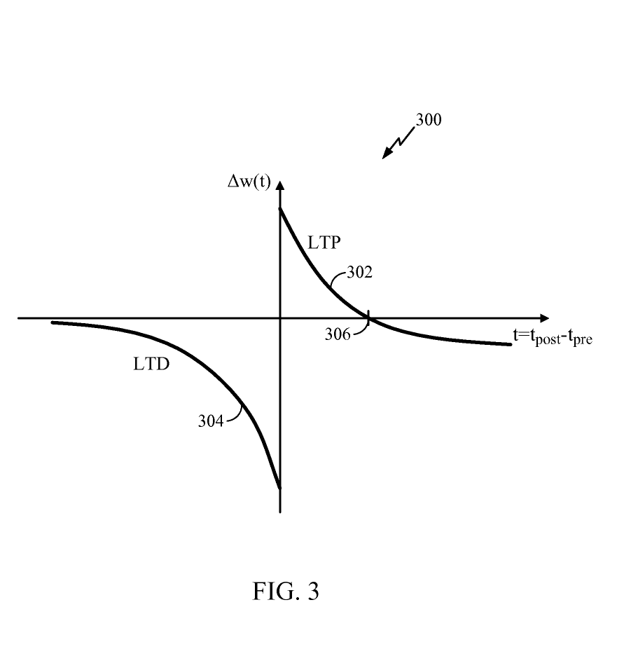

FIG. 3 illustrates an example graph 300 of a synaptic weight change as a function of relative timing of pre-synaptic and post-synaptic spikes in accordance with STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1 (presynaptic layer). In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset p may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, yᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

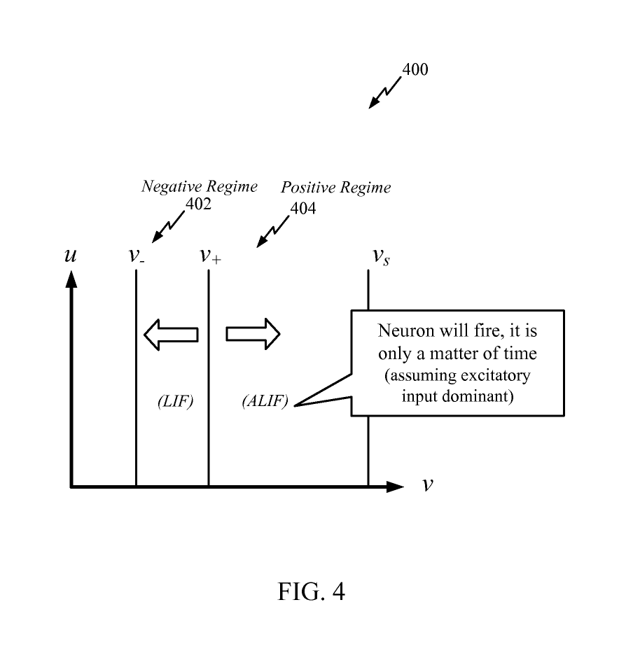

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model is defined to spike when the voltage v reaches a value vₛ. Subsequently, the state is typically reset at a reset event (which technically may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is

$$Δ {t}_{S} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime p may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Neural Coding

A useful neural network model, such as one comprised of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

### Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

### Inputs

An input to a neuron model may include Dirac delta functions, such as inputs as currents, or conductance-based inputs. In the latter case, the contribution to a neuron state may be continuous or state-dependent.

### Example Spike Time Windowing

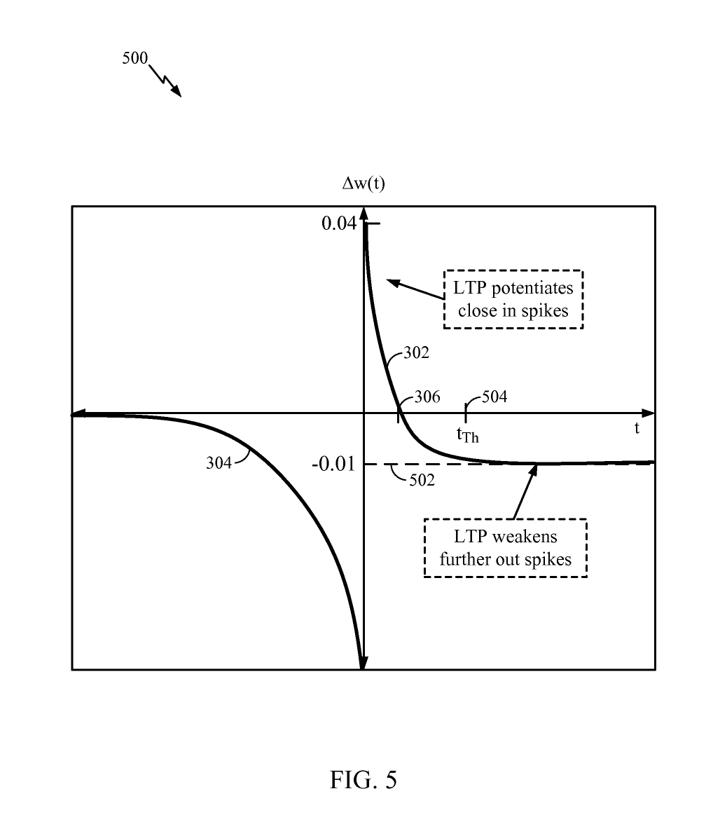

FIG. 5 is an example double exponential spike-timing dependent plasticity (STDP) curve 500, in accordance with certain aspects of the present disclosure. FIG. 5 is similar to FIG. 3 described above, but with example parameter values shown. As described above, LTP potentiates post-synaptic spikes that occur shortly after pre-synaptic spikes (i.e., close in spikes), but weakens post-synaptic spikes that occur after the point of cross-over 306 (i.e., further out spikes). Beyond a threshold time (t_{Th}) 504, the synaptic weight change approaches an asymptotic value 502, which may be less than or equal to 0 (e.g., −0.01 as shown in FIG. 5).

In certain software simulations of artificial nervous systems, the STDP update rules have both long-term potentiation (LTP) and long-term depression (LTD) processed on each post-synaptic and pre-synaptic spike, respectively. This is likely too costly for “real-time” hardware implementation for large networks because the memory layouts typically facilitate keeping either fan-out or fan-in topologies and because existing LTP approaches may process based on fan-in, while existing LTD approaches may process based on fan-out.

One initial hardware solution involved a triplet rule for each pre-synaptic spike, based on processing one subsequent post-synaptic spike time as LTP and one prior post-synaptic spike time as LTD for the corresponding pre-synaptic spike time. Any other post-synaptic spikes were ignored. However, the triplet rule was not successfully implemented for certain neural models (especially when the STDP curve had a non-zero asymptotic value, as illustrated in FIG. 5), and further analysis showed this problem was likely to occur with other models, as well.

Accordingly, what is needed are techniques and apparatus for processing STDP rules given hardware limitations, while still enabling learning for existing and future neural models.

### The Buffer Method

Certain aspects of the present disclosure involve using a buffer at each artificial neuron that keeps track of up to a predetermined number (N) of spikes (e.g., 6 to 20 spikes) and discards (or otherwise effectively ignores) any other spikes. For certain aspects, the buffer may not only keep up to N spikes, but may also only retain spikes out of this group that occurred within a predetermined amount of time in the past (e.g., 2 to 4 seconds). For certain aspects, the buffer may be a first-in, first-out (FIFO) buffer that keeps the N most recent spikes and discards the oldest spikes. For other aspects, the buffer may randomly select the spikes to keep or may select the spikes to keep accordingly to some intelligent algorithm based on certain selection criteria (e.g., discarding one or more spikes in a group that are close together in time, leaving a single spike representing this group).

According to certain aspects, the buffer may be a dynamic buffer where the number of retained spike times changes, rather than a static buffer with a fixed number of retained spike times. This dynamic number of retained spike times may be adjusted based on the activity level for the particular artificial neuron to which the buffer corresponds. In other words, the number of retained spike times may be increased if there is a relatively large amount of spiking activity in a certain period, whereas the number may be reduced if there is sparse spiking activity.

Furthermore, STDP updates may be processed at a delay after each pre-synaptic spike (or each post-synaptic spike, depending on implementation) according to a window, as described below. Therefore, up to N post-synaptic spikes (or pre-synaptic spikes) may be processed for LTP (or LTD) for each pre-synaptic spike.

In this manner, an artificial nervous system with learning capabilities may be successfully implemented in hardware, without having to process what may be considered an excessive number of spikes to effectuate synaptic plasticity. Use of the buffer thus provides an advantage over implementations using the triplet rule.

Before explaining the process for performing the STDP updates, certain terms related to the window should be defined. Although the STDP updates may be implemented based on either pre-synaptic spikes or post-synaptic spikes, the examples presented below perform STDP updates based on pre-synaptic spikes for ease of description. Based on this explanation, a person skilled in the art will realize how the STDP updates may be similarly performed based on post-synaptic spikes.

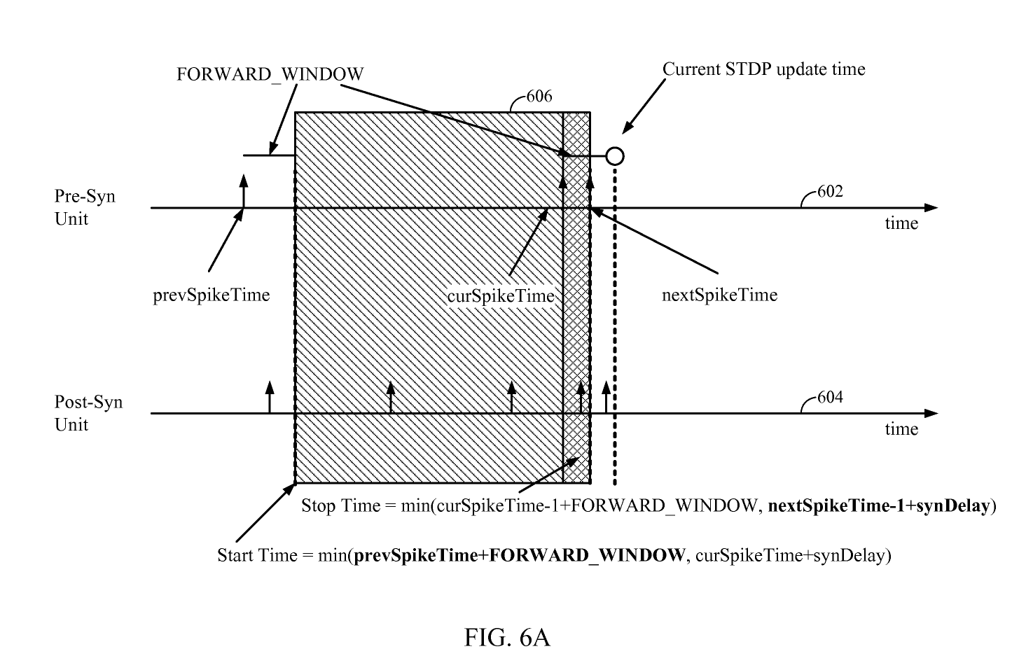

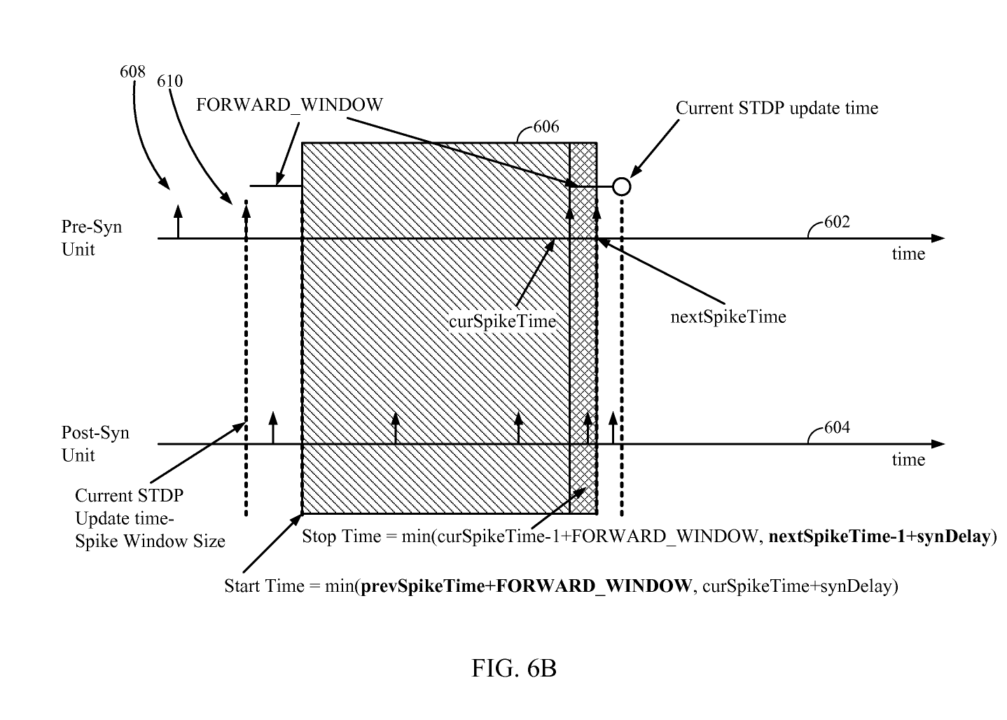

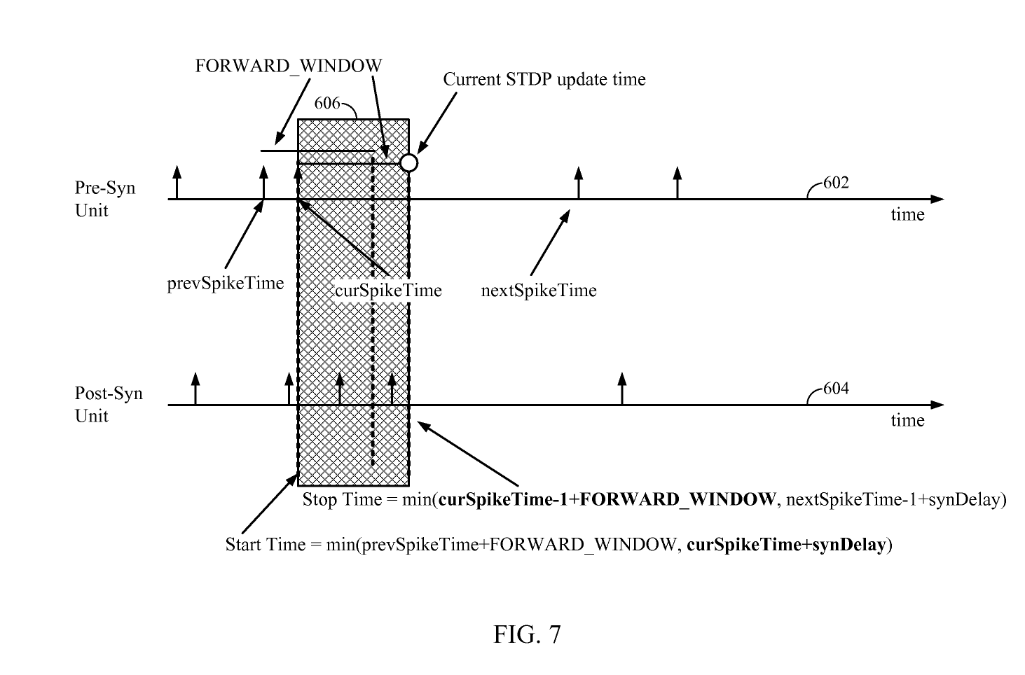

The reader may refer to the example windows 606 in FIGS. 6A, 6B, and 7 for illustrations of particular times associated with an STDP update triggered by a given pre-synaptic spike. Since STDP updates may be performed for a synapse between a pre-synaptic artificial neuron and a post-synaptic artificial neuron and because each artificial neuron may keep track of its generated output spikes (or received input spikes, for certain aspects), FIGS. 6A, 6B, and 7 present a timeline 602 of output (or input) spikes for a pre-synaptic unit and a timeline 604 of output (or input) spikes for a post-synaptic unit. Relative to the synapse between the pre-synaptic and post-synaptic units, spikes in the timeline 602 are considered pre-synaptic spikes, while spikes in the timeline 604 are considered post-synaptic spikes.

The current STDP update time (STDPUpdateTime) generally refers to the time at which the STDP update for the given pre-synaptic spike is performed. The FORWARD_WINDOW generally refers to the time delay between when a pre-synaptic spike occurs and when the synapse update is triggered. For certain aspects, the FORWARD_WINDOW may be a fixed time delay for all synapses. For other aspects, the FORWARD_WINDOW may be a fixed time delay specific to different synapses or different synapses types or a variable time delay based, for example, on a resource model value or spiking activity (e.g., whether the number of post-synaptic spikes after a pre-synaptic spike meets and/or exceeds a threshold).

The term “synDelay” generally refers to a synaptic delay of the synapse between the pre-synaptic and post-synaptic units, not to be confused with the FORWARD_WINDOW delay. The synaptic delay may be expressed in terms of time unit tau (τ) (e.g., a delay of 1, 3, or 6 tau), where tau is the step size for the artificial nervous system. According to certain aspects of the present disclosure, the synaptic delay (e.g., in temporal learning models) may be updated in addition to the STDP weight update.

As used herein, “curSpikeTime” generally refers to the time stamp of the pre-synaptic spike that triggered the STDP update. The term “prevSpikeTime” generally refers to the time stamp of the latest pre-synaptic spike in the buffer before curSpikeTime. For certain aspects, prevSpikeTime may be set to negative infinity (−∞) if the previous spike time was pushed out of the buffer before the STDP update. For other aspects in this situation, prevSpikeTime may be set to the earliest time in the past the artificial nervous system is capable of representing with the buffer (e.g., 2 to 4 seconds prior to curSpikeTime). As used herein, “nextSpikeTime” generally refers to the time stamp of the earliest pre-synaptic spike in the buffer after curSpikeTime. For certain aspects, nextSpikeTime may be set to positive infinity (+∞) if a next spike time has not yet occurred. For other aspects in this situation, nextSpikeTime may be set to curSpikeTime+1+FORWARD_{—} WINDOW.

As used herein, “startTime” and “stopTime” define the boundaries of the window 606 and are the earliest and latest spike times, respectively, for which post-synaptic spikes will have LTP updates during the current STDP update. The startTime may be equal to the minimum between synDelay added to curSpikeTime and the FORWARD_WINDOW delay added to prevSpikeTime (i.e., startTime=min(curSpikeTime+synDelay, prevSpikeTime+FORWARD_WINDOW)). The stopTime may be equal to the minimum between synDelay added to nextSpikeTime−1 and the FORWARD_WINDOW delay added to curSpikeTime−1 (i.e., stopTime=min(nextSpikeTime−1+synDelay, curSpikeTime−1+FORWARD_{—} WINDOW)).

With these definitions, the window for each subsequent pre-synaptic spike is separated from the window for the previous pre-synaptic spike by the discrete time increment (i.e., step size) for the artificial nervous system (i.e., consecutive windows do not overlap), such that there is no double counting of post-synaptic spikes. In other words, the startTime of the window associated with a subsequent pre-synaptic spike may occur one tau after the stopTime of the window associated with the previous pre-synaptic spike. In this manner, other LTP events outside the window for the current pre-synaptic spike are captured in a window for one of the other pre-synaptic spikes.

As an alternative, “stopTime” and “startTime” may be defined as the latest spike time and one tau earlier than the earliest spike time, respectively, for which post-synaptic spikes will have LTP updates during the current STDP update. The startTime may be equal to the minimum between synDelay added to curSpikeTime−1 and the FORWARD_WINDOW delay added to prevSpikeTime−1 (i.e., startTime=min(curSpikeTime−1+synDelay, prevSpikeTime−1+FORWARD_WINDOW)). The stopTime may be equal to the minimum between synDelay added to nextSpikeTime and the FORWARD_WINDOW delay added to curSpikeTime (i.e., stopTime=min(nextSpikeTime+synDelay, curSpikeTime+FORWARD_WINDOW)). In this case, spikes may be processed one tau after the startTime. In this manner, consecutive windows are still non-overlapping, and double-counting of post-synaptic spikes is avoided. Other alternatives to those described above may also be utilized.

FIGS. 6A and 6B illustrate an example window 606 where startTime is based on prevSpikeTime+FORWARD_WINDOW and stopTime is based on nextSpikeTime−1+synDelay. In contrast, FIG. 7 illustrates an example window 606 where startTime is based on curSpikeTime+synDelay and stopTime is based on curSpikeTime−1+FORWARD WINDOW.

In FIG. 6B, the previous pre-synaptic spike at 608 has dropped out of the buffer due to the history of spike times being retained (i.e., the spike at 608 occurred at a time before the predetermined amount of time being kept for curSpikeTime). Since there are no pre-synaptic spike times in the buffer, the window 606 may be generated based on a phantom pre-synaptic spike at 610. The time of the phantom pre-synaptic spike at 610 may be considered as occurring at the predetermined amount of time (e.g., 2 to 4 seconds) before curSpikeTime and treated as prevSpikeTime for determining startTime of the window 606.

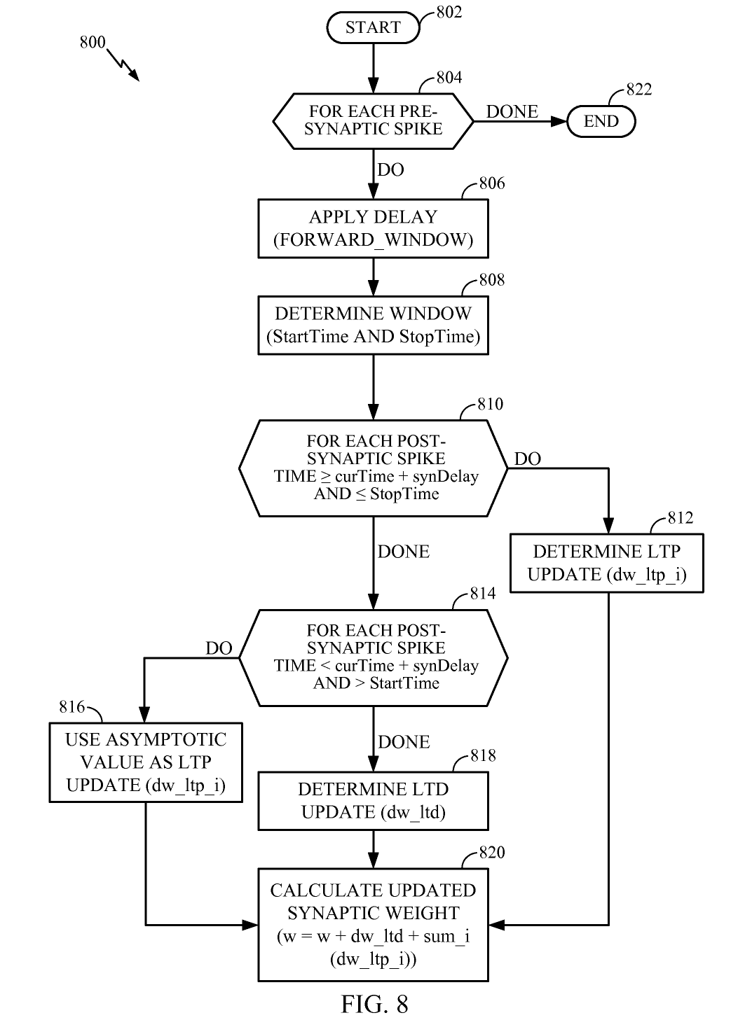

FIG. 8 is a flow diagram of example operations 800 for updating STDP for each pre-synaptic spike, in accordance with certain aspects of the present disclosure. The buffer for each artificial neuron may keep track of the last 8 spike times for up to 2 seconds in the past, for example. For the STDP updates, the operations 800 may begin at 802.

After each pre-synaptic spike at 804, wait a delay (e.g., equal to FORWARD_WINDOW) at 806, determine a window at 808 (e.g., according to the definitions for startTime and stopTime above) and then perform a set of LTP and LTD updates. For certain aspects, the FORWARD_WINDOW may most likely be greater than or equal to the portion of the LTP curve that varies for double-exponential and other STDP curves. For example, the FORWARD_WINDOW may be at least as long as the threshold time 504 separating the non-asymptotic LTP values from the asymptotic values for the STDP curve 500 of FIG. 5.

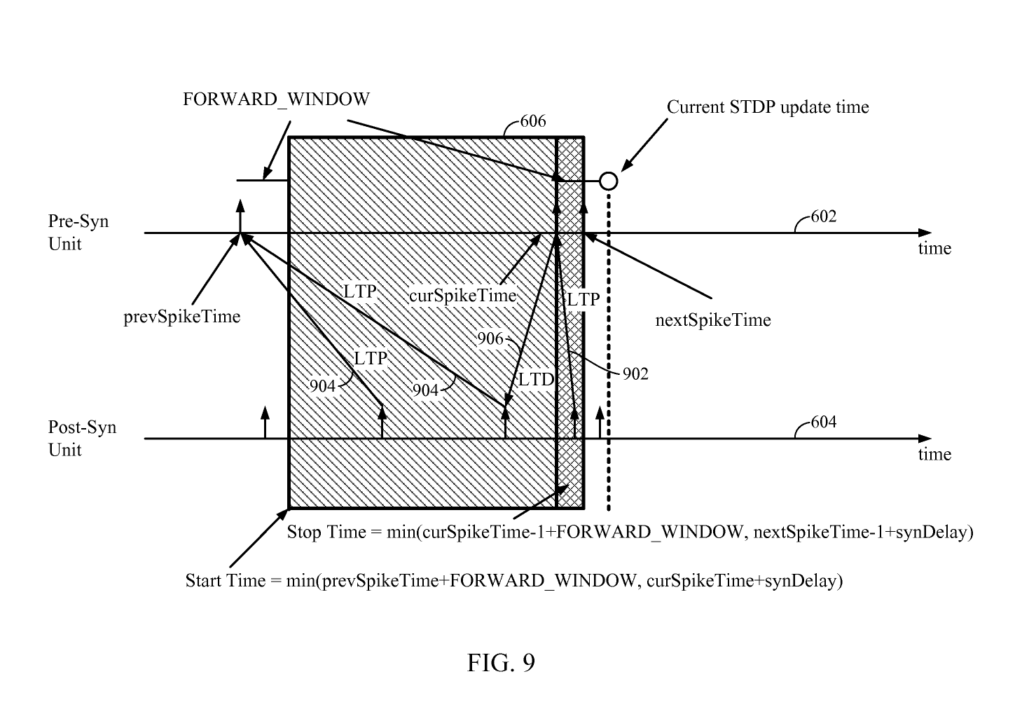

LTP updates may be performed for all post-synaptic spikes in the post-synaptic unit buffer in a window of time greater than startTime and less than or equal to stopTime. For post-synaptic spikes in the window 606, for each post-synaptic spike time 902 in FIG. 9 greater than or equal to the curSpikeTime+synDelay at 810, the LTP update may be determined at 812 by first determining the relative LTP time difference (LTP-time-delta) as post.spikeTimeBuffer[i]−(curSpikeTime+synDelay). Then, each LTP-time-delta may be converted to a synaptic weight change (dw_ltp_i), either parametrically or from a lookup table (LUT), based on an STDP curve (e.g., STDP curve 500 in FIG. 5).

At 814, for each post-synaptic spike time 904 in FIG. 9 in the window 606 less than the curSpikeTime+synDelay, the number of these post-synaptic spike times 904 may be counted, and the asymptotic LTP value (e.g., asymptotic value 502 in FIG. 5) may be used as the synaptic weight change (dw_ltp_i) for these spike times at 816. While the actual LTP value for these post-synaptic spike times 904 may be used, using the asymptotic value instead should save hardware resources including lookup (or computation) time without sacrificing much accuracy in the synaptic plasticity. If the actual LTP value were to be used instead of the asymptotic value at 816, the LTP update may be determined by first determining the relative LTP time difference (LTP-time-delta) as post.spikeTimeBuffer[i]−(prevSpikeTime+synDelay). Then, each LTP-time-delta may be converted to a synaptic weight change (dw_ltp_i), either parametrically or from a lookup table (LUT), based on an STDP curve (e.g., STDP curve 500 in FIG. 5).

At 818, one LTD update (dw_ltd) is determined for the post-synaptic spike 906 just prior to the curSpikeTime+synDelay in FIG. 9. The LTD update may be determined by computing the time difference (LTD-time-delta=curSpikeTime+_synDelay−post.spikeTimeBuffer[postMostRecentBeforeCurrent]) between these spike times. Then, the LTD-time-delta may be converted to a synaptic weight change (dw_ltd), either parametrically or via a LUT.

At 820, the synaptic weight (w) may be updated, based on the previous synaptic weight as w=w+dw_ltd+sum_i (dw_ltp_i), where i is the number of buffered post-synaptic spikes in the window 606. The updated synaptic weight may then be stored in memory for the synapse.

The operations 800 may end at 822, once STDP updates have been performed for all the pre-synaptic spikes relative to a given synapse in an artificial nervous system. These same operations 800 may be performed for each synapse in the artificial nervous system having a pre-synaptic and a post-synaptic artificial neuron.

### The Counting Method

Certain aspects of the present disclosure involve counting output spikes generated (or alternatively, input spikes received) at each neuron (e.g., in a count variable (C) that is incremented each time an input spike is received) and marking the count in each synapse. For certain aspects, a history of any spikes in the last period T (e.g., 100 tau, where tau is a single time step for the artificial nervous system) may also be kept. The STDP LTP update may then be computed based on a desired number of spikes (k) (e.g., k=3) out of the received spikes in a window based on received spikes for a prior (or a subsequent) artificial neuron (up to the spikes kept in the history, for certain aspects).

For a double-exponential STDP curve, for example, the synaptic weight change may be calculated based on k LTP updates according to the non-asymptotic portion of the curve and the asymptotic value 502 effectively multiplied by the difference between the count and the desired number of spikes (i.e., C−k). The description reads “effectively multiplied,” since C−k asymptotic values may be summed to achieve the mathematical equivalent, rather than involving actual multiplication. The k LTP updates may be determined by first determining the relative LTP time difference (LTP-time-delta) for each of the k spikes, which may be computed as the difference between the recorded spike time for the artificial neuron and the starting time of the window (e.g., the previous pre-synaptic spike time). Then, each LTP-time-delta may be converted to a synaptic weight change (dw_ltp_i), either parametrically or from a lookup table (LUT), based on the STDP curve.

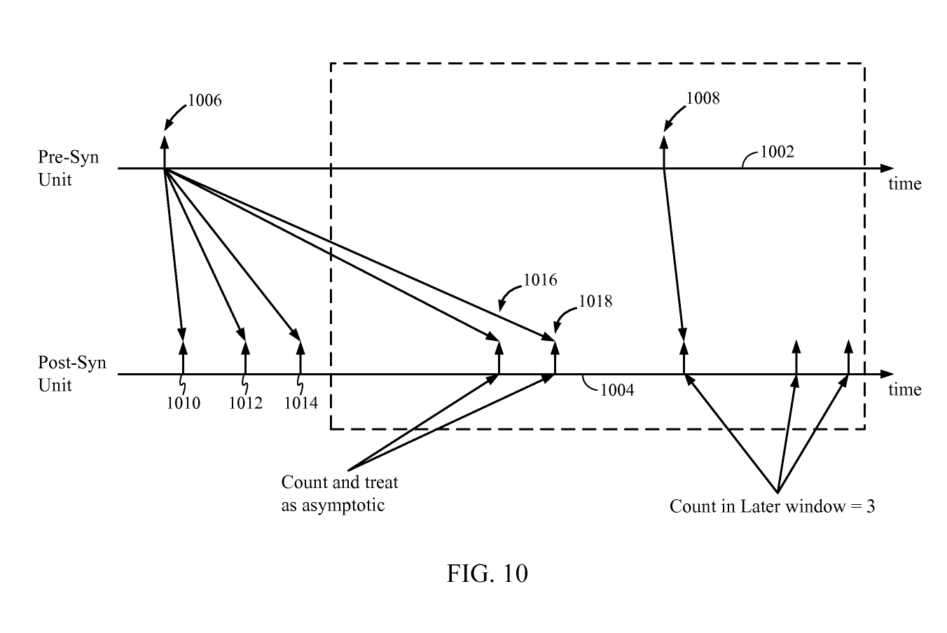

As an example, FIG. 10 presents a timeline 1002 of output (or input) spikes for a pre-synaptic unit and a timeline 1004 of output (or input) spikes for a post-synaptic unit. Relative to a synapse between the pre-synaptic and post-synaptic units, spikes in the timeline 1002 are considered pre-synaptic spikes, while spikes in the timeline 1004 are considered post-synaptic spikes. Post-synaptic spikes between a pre-synaptic spike at 1006 and a subsequent pre-synaptic spike at 1008 may be counted. In FIG. 10, there are 5 post-synaptic spikes between the pre-synaptic spikes 1006, 1008. If the desired number of spikes for LTP updates is 3 (i.e., k=3), then the spike times for the first three post-synaptic spikes 1010, 1012, 1014 may be used in determining the LTP updates (e.g., in the non-asymptotic portion of a double-exponential STDP curve). The last two post-synaptic spikes 1016, 1018 in the count may be treated as having the asymptotic value 502 for the LTP update, as described above. The STDP update may be performed at the time of the subsequent pre-synaptic spike at 1008, or shortly thereafter.

For certain aspects, rather than using the initial k spikes in the count, a random selection of k spike times (or an intelligent selection of k spike times made based on suitable criteria) may be used instead for the LTP updates. The other non-selected spike times in the count may be treated as having the asymptotic value.

According to certain aspects, one particular counting method may entail decreased hardware resources by only updating the count per neuron, instead of per synapse. This method involves having a running count in the artificial neuron. Then the synapse keeps tracks of the previous count value+k and subtracts the new count value from the previous to get the effective count.

### Additional Features

According to certain aspects, the counting method and the buffer method may be combined and used together.

For certain aspects, the artificial nervous system may have a linked list of spike times with memory shared across artificial neurons.

For certain aspects, the spike times may allow using finer resolution sub-tau time for STDP updates. Here, due to the resolution of recorded spike times (based on the number of bits used), an artificial neuron can determine the sub-tau spike time and record that time, while processing is done in tau points of time. This sub-tau spike time may then be used in the STDP table lookup, rather than a spike time based on coarser tau increments. For certain aspects, this sub-tau spike time may be used in the neuron input filter and update equations to account for a spike arrival at a sub-tau spike time.

As described above, instead of processing based on pre-synaptic spike times, the algorithm may be inverted. In other words, processing may be performed based on post-synaptic spike times with one LTP per post-synaptic spike and LTD for a window of pre-synaptic spikes.

Certain aspects of the present disclosure involve processing consecutive non-overlapping windows of spike times. Additionally or alternatively to processing LTP and/or LTD events with these windows, other spike-based plasticity updates may be computed, such as updates based on resource models, delay plasticity based on spike times, and structural plasticity based on spike times and weights (e.g., with updates triggered by a pre-synaptic spike processed for this pre-synaptic spike and updates triggered by a post-synaptic spike processed for the corresponding window of post-synaptic spikes).

For certain aspects, additional LTP and/or LTD events may be associated with and processed for certain spikes in addition to those described, for example, with respect to FIGS. 8-10. In other words, a person skilled in the art may extend LTP and/or LTD computations described above, such that LTP and/or LTD updates may be computed based on the j nearest (pre-before-post and/or post-before-pre) spike times.

According to certain aspects, the non-overlapping windows may be defined in manners other than those described above. For example, the windows may be defined by shifting the current window, processing from prevSpikeTime+1 to curSpikeTime, or processing from prevSpikeTime+1+FORWARD_WINDOW to curSpikeTime+FORWARD_WINDOW. The last two examples may involve processing multiple LTP and/or LTD updates for multiple spikes, whereas one advantage the aspects described in detail above have over these examples is that at most two pre-synaptic spike times (prevSpikeTime and curSpikeTime) are considered for LTP updates and only one (curSpikeTime) is considered for LTD updates.

### Example Operation of an Artificial Nervous System

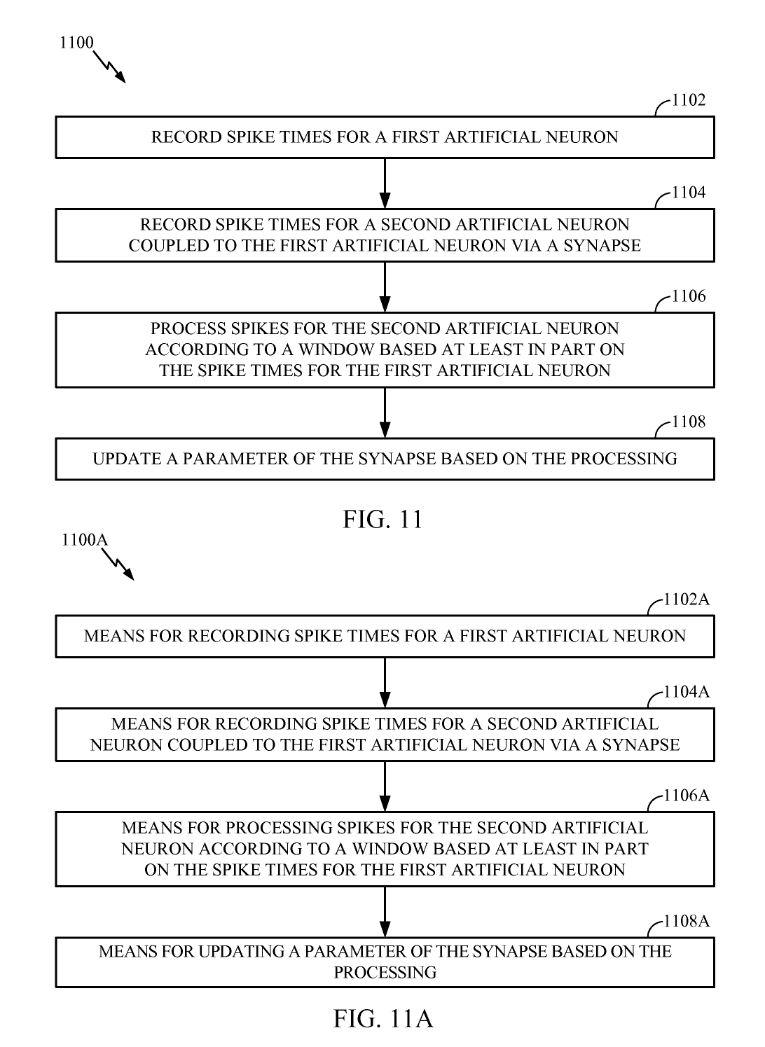

FIG. 11 is a flow diagram of example operations 1100 for operating an artificial nervous system, in accordance with certain aspects of the present disclosure. The operations 1100 may be performed in hardware (e.g., by one or more neural processing units, such as a neuromorphic processor), in software, or in firmware. The artificial nervous system may be modeled on any of various biological or imaginary nervous systems, such as a visual nervous system, an auditory nervous system, the hippocampus, etc.

The operations 1100 may begin, at 1102, by recording spike times for a first artificial neuron. Recording spike times may include storing times when spiking events occur in memory (e.g., according to the step size (tau) for the artificial nervous system). At 1104, spike times for a second artificial neuron may be recorded. The second artificial neuron may be coupled to the first artificial neuron via a synapse. For certain aspects, the first artificial neuron is a presynaptic neuron, and the second artificial neuron is a postsynaptic neuron, relative to the synapse.

At 1106, spikes for the second artificial neuron may be processed according to a window. The window may be based at least in part on the spike times for the first artificial neuron.

At 1108, a parameter of the synapse may be updated, based on the processing at 1106. The parameter of the synapse may be at least one of a weight, a delay, a resource value, a neurotransmitter characteristic (e.g., an amount or duration of a neurotransmitter, such as acetylcholine (Ach), dopamine, gamma-aminobutyric acid (GABA), norepinephrine, or epinephrine), or a sum-delta weight of the synapse. The strength of synapses may vary according to two different time scales, represented by typical synaptic weights and sum-delta weights. A typical synaptic weight, as described above and in association with FIGS. 3 and 5, may be adjusted on the slower time scale of learning, and may represent permanent memory. In contrast, a sum-delta weight may be adjusted much more quickly, such as on the same time scale as the step size (tau) of the artificial nervous system. For certain aspects, the LTP and/or LTD weight changes may be accumulated in a sum-delta weight variable instead of directly into the variable. Then, the sum-delta weight variable may be added to the typical synaptic weight either at a slower time scale (as described above) or modulated by a dopamine signal.

As used herein, a resource value generally refers to a value that is multiplied with the synaptic weight when a synapse transmits a spike, according to certain neuron models. When the neuron spikes, some amount of the resource is consumed, which then starts to build back up exponentially. If the neuron spikes again before the resource has built all the way back up, then the spike will have a reduced weight. This results in a train of quick successive spikes on a synapse have less and less potentiation. According to certain aspects of the present disclosure, the computations on the amount of resources used and available may be performed in a windowed manner.

According to certain aspects, the window begins at a first spike time for the first artificial neuron and ends at a second spike time for the first artificial neuron. For certain aspects, the processing at 1106 involves ignoring or discarding any spike times for the second artificial neuron in the window, but outside a (predetermined) amount of time (e.g., a predetermined amount of time before the second spike time for the first artificial neuron). The first and second spike times may be for two consecutive spikes for the first artificial neuron.

According to certain aspects, the processing at 1106 involves determining a set of the spikes for the second artificial neuron in the window and in the (predetermined) amount of time (e.g., 100 tau), based at least in part on a (predetermined) number of spikes (e.g., 3). For certain aspects, determining the set of the spikes for the second artificial neuron involves at least one of selecting the initial spikes for the second artificial neuron in the window and in the (predetermined) amount of time or randomly selecting the spikes for the second artificial neuron in the window and in the (predetermined) amount of time, according to the (predetermined) number of spikes. For certain aspects, the parameter of the synapse is a weight of the synapse. In such cases, the processing may also involve counting a number of the spikes for the second artificial neuron in the window and determining first weight change values associated with the recorded spike times for the set of the spikes, based at least in part on a first portion of a spike-timing dependent plasticity (STDP) equation or lookup table. For certain aspects, the processing may also include determining second weight change values associated with (the recorded spike times for) the spikes for the second artificial neuron in the window that are not in the set of the spikes, based at least in part on a second portion of the STDP equation or lookup table.

According to certain aspects, the STDP equation or lookup table may be based at least in part on any of various suitable functions, such as a double exponential function, a truncated Gaussian function, or a piecewise linear function (e.g., a piecewise constant function). The function may be linear or nonlinear, continuous or non-continuous. For certain aspects, the STDP equation or lookup table may be based at least in part on a function (e.g., a double exponential function) having an asymptotic value for positive times above a threshold time, wherein the first portion is below the threshold time, and wherein the second portion is above the threshold time. For example, the asymptotic value may be less than or equal to 0. For certain aspects, the asymptotic value may be non-continuous with another portion of an STDP curve based on the STDP equation or lookup table.

For certain aspects, the second weight change values may equal the asymptotic value. For certain aspects, updating the parameter of the synapse may involve effectively multiplying the asymptotic value by a difference between the counted number of the spikes in the window and a number of elements in the set of the spikes; and summing a result of the multiplication, the first weight change values, and a previous weight of the synapse to generate an updated weight of the synapse. Effectively multiplying may include actually multiplying, adding values to achieve the same result as actually multiplying, or some combination thereof

According to certain aspects, recording the spike times for the second artificial neuron may involve keeping up to a predetermined number (e.g., between 6 and 20 inclusive) of the spike times for the second artificial neuron and ignoring or discarding any spike times above the predetermined number. For certain aspects, keeping up to the predetermined number of the spike times comprises keeping up to the predetermined number of the most recent spike times for the second artificial neuron, and ignoring or discarding spike times above the predetermined number includes ignoring or discarding older spike times when newer spike times are recorded. For certain aspects, recording the spike times for the second artificial neuron may also involve keeping up to the predetermined number of the spike times for the second artificial neuron that occur within a (predetermined) amount of time (e.g., between 2 and 4 seconds inclusive) and ignoring or discarding any spike times outside the predetermined amount of time or above the predetermined number. For certain aspects, ignoring or discarding spike times above the predetermined number entails randomly ignoring or discarding an older spike time when a new spike time arrives that would make the kept number of spike times greater than the predetermined number.

According to certain aspects, keeping up to the predetermined number includes keeping up to the predetermined number of the spike times for the second artificial neuron in a buffer. For certain aspects, the buffer may be a first-in, first-out (FIFO) buffer that keeps up to the predetermined number of the most recent spike times for the second artificial neuron and discards older spike times when newer spike times are recorded. For other aspects, the buffer may randomly drop certain spikes or may use an algorithm for keeping certain spikes while discarding others.

According to certain aspects, the window may begin at a first minimum time between a (predetermined) delay (e.g., FORWARD_WINDOW) added to a first spike time for the first artificial neuron and a synaptic delay added to a second spike time for the first artificial neuron. The second spike time may be subsequent to the first spike time, and the parameter of the synapse may be updated for the second spike time. For certain aspects, the first and second spike times are for two consecutive spikes for the first artificial neuron. Updating the parameter of the synapse may occur at the delay added to the second spike time for the first artificial neuron. For certain aspects, the delay is greater than a non-asymptotic portion of a (double exponential) STDP function. For certain aspects, the window ends at a second minimum time between the delay minus a step size for the artificial nervous system (e.g., tau) added to the second spike time for the first artificial neuron and the synaptic delay minus the step size added to a third spike time for the first artificial neuron. The third spike time may be subsequent to the second spike time. For certain aspects, the second and third spike times are for two consecutive spikes for the first artificial neuron.

According to certain aspects, the parameter of the synapse is a weight of the synapse. In such aspects, the processing may involve determining first weight change values associated with the recorded spike times for the second artificial neuron within the window and greater than or equal to the second spike time that have been kept, based at least in part on a first portion of a STDP equation or lookup table. For certain aspects, the processing may further involve determining second weight change values associated with the recorded spike times for the second artificial neuron within the window and less than the second spike time that have been kept, based at least in part on a second portion of the STDP equation or lookup table.

According to certain aspects, the STDP equation or lookup table is based at least in part on a function (e.g., a double exponential function) having an asymptotic value for positive times above a threshold time. The first portion may be below the threshold time, and the second portion may be above the threshold time. The asymptotic value may be less than or equal to 0. For certain aspects, the second weight change values equal the asymptotic value. For certain aspects, the processing may also involve determining a third weight change value associated with one of the recorded spike times for the second artificial neuron in the window that has been kept, just prior to the second spike time for the first artificial neuron, based at least in part on a third portion of the STDP equation or lookup table.

According to certain aspects, updating the parameter of the synapse may involve (effectively) multiplying the second weight change values by a number of the recorded spike times of the second artificial neuron in the window and less than the second spike time that have been kept. Then, a result of the multiplication, the first weight change values, the third weight change value, and a previous weight of the synapse may be summed to generate an updated weight of the synapse.

According to certain aspects, the artificial nervous system is configured to operate according to a discrete time increment. In such cases, at least one of the recording or the processing may be based on a resolution finer than the discrete time increment (e.g., sub-tau spike timing).

According to certain aspects, if a spike arrives that would result in keeping more than an allowed number of spikes, then one of the spikes (or spike times) may be discarded. This dropping of one of the spikes (or spike times) may be performed randomly and may be based on some statistical distribution, such as a uniform distribution over the spikes including the new spike (e.g., the new spike may be dropped), a uniform distribution over the spikes excluding the new spike (e.g., the new spike may not be dropped), a distribution favoring dropping older spikes, or a distribution that weights dropping spikes based on time deltas between spikes.

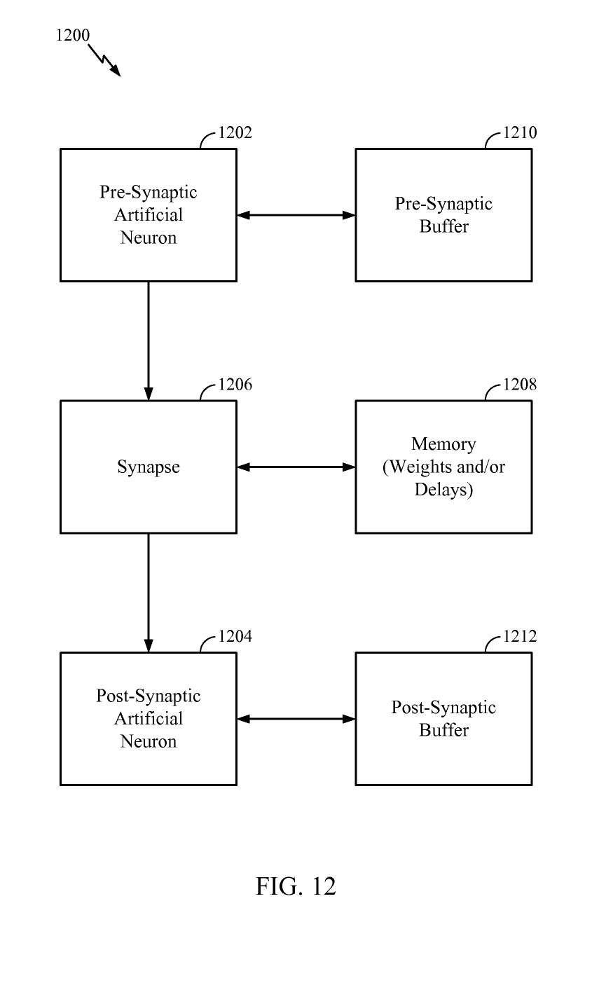

FIG. 12 is a block diagram 1200 of an example hardware implementation for implementing synaptic updates, in accordance with certain aspects of the present disclosure. A pre-synaptic artificial neuron 1202 (neural processing unit) may be connected with a post-synaptic artificial neuron 1204 via a synapse 1206 (similar to a synapse 104 in FIG. 1). As described above, the synapse 1206 may receive a spike output from the pre-synaptic artificial neuron 1202 and scale and/or delay the spike according to a synaptic weight and/or a delay, which may be stored in a memory 1208. The memory 1208 may be associated with the synapse 1206 or with multiple synapses including the synapse 1206. The scaled and/or delayed spike from the synapse 1206 is then sent to the post-synaptic artificial neuron 1204 to be received as an input spike.

Furthermore, a pre-synaptic buffer 1210 (a post-synaptic buffer 1212) may be associated with the pre-synaptic artificial neuron 1202 (the post-synaptic artificial neuron 1204). The buffer 1210 (1212) may keep a history of spikes received at the pre-synaptic artificial neuron 1202 (the post-synaptic artificial neuron 1204), discarding certain spikes as described above. For certain aspects, the buffer 1210 (1212) may be a FIFO buffer, as described above.

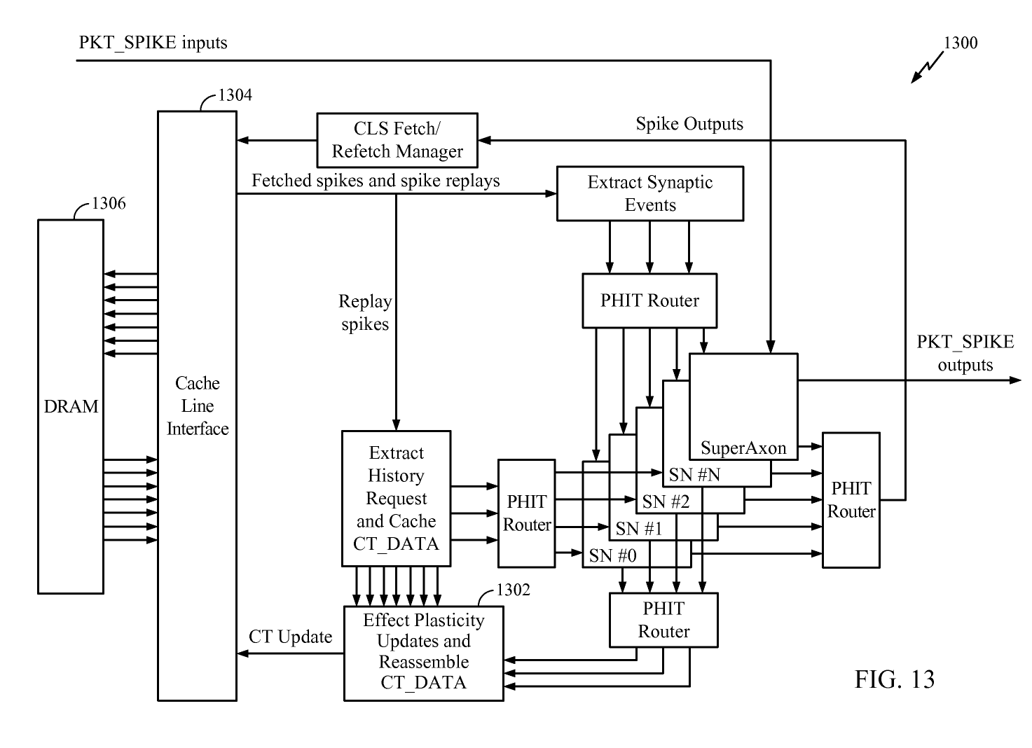

FIG. 13 is a block diagram 1300 of an example hardware implementation for an artificial nervous system, in accordance with certain aspects of the present disclosure. STDP updating, as described above, may occur in an Effect Plasticity Updates and Reassemble block 1302. For certain aspects, the updated synaptic weights may be stored (via a cache line interface 1304) in off-chip memory (e.g., dynamic random access memory (DRAM) 1306).

In a typical artificial nervous system, there are many more synapses than artificial neurons, and for a large neural network, processing the synapse updates in an efficient manner is desired. The large number of synapses may suggest storing the synaptic weight and other parameters in memory (e.g., DRAM 1306). When artificial neurons generate spikes in a so-called “super neuron (SN),” the neurons may forward those spikes to the post-synaptic neurons through DRAM lookups to determine the post-synaptic neurons and corresponding neural weights. To enable fast and efficient lookup, the synapse ordering may be kept consecutively in memory based, for example, on fan-out from a neuron. Later when processing STDP updates in block 1302, efficiency may dictate processing the updates based on a forward fan-out given this memory layout since the DRAM or a large lookup table need not be searched to determine the reverse mapping for LTP updates. The approach shown in FIG. 13 facilitates this. The Effect Plasticity Updates and Reassemble block 1302 may query the super neurons in an effort to obtain the pre- and post-synaptic spike times, again reducing the amount of state memory involved.

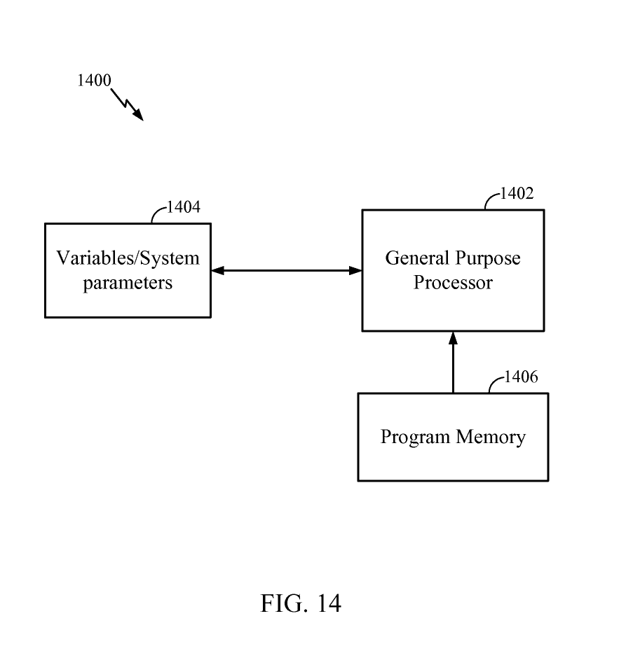

FIG. 14 illustrates an example block diagram 1400 of components for operating an artificial nervous system using a general-purpose processor 1402 in accordance with certain aspects of the present disclosure. Variables (neural signals), synaptic weights, and/or system parameters associated with a computational network (neural network) may be stored in a memory block 1404, while instructions related executed at the general-purpose processor 1402 may be loaded from a program memory 1406. In an aspect of the present disclosure, the instructions loaded into the general-purpose processor 1402 may comprise code for recording spike times for a first artificial neuron, code for recording spike times for a second artificial neuron coupled to the first artificial neuron via a synapse, code for processing spikes for the second artificial neuron according to a window based at least in part on the spike times for the first artificial neuron, and code for updating a parameter of the synapse based on the processing.

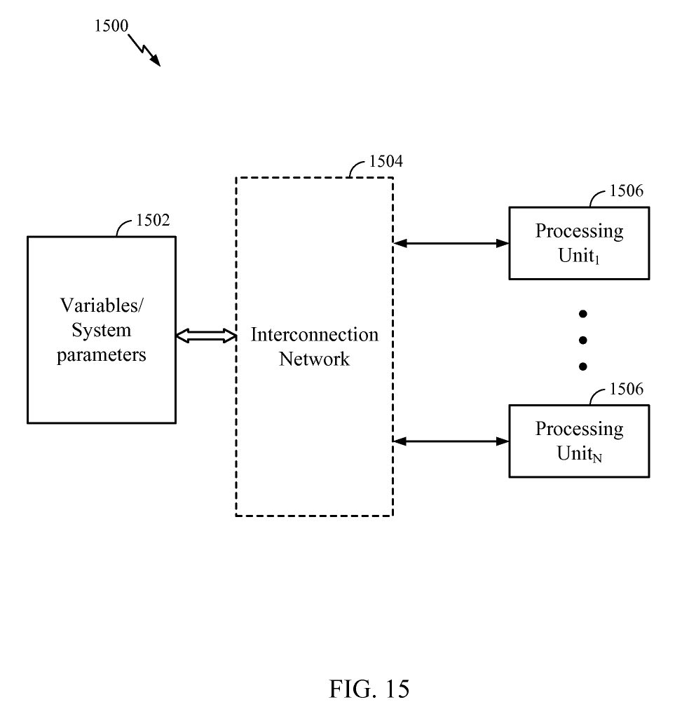

FIG. 15 illustrates an example block diagram 1500 of components for operating an artificial nervous system where a memory 1502 can be interfaced via an interconnection network 1504 with individual (distributed) processing units (neural processors) 1506 of a computational network (neural network) in accordance with certain aspects of the present disclosure. Variables (neural signals), synaptic weights, and/or system parameters associated with the computational network (neural network) may be stored in the memory 1502, and may be loaded from the memory 1502 via connection(s) of the interconnection network 1504 into each processing unit (neural processor) 1506. In an aspect of the present disclosure, the processing unit 1506 may be configured to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing.

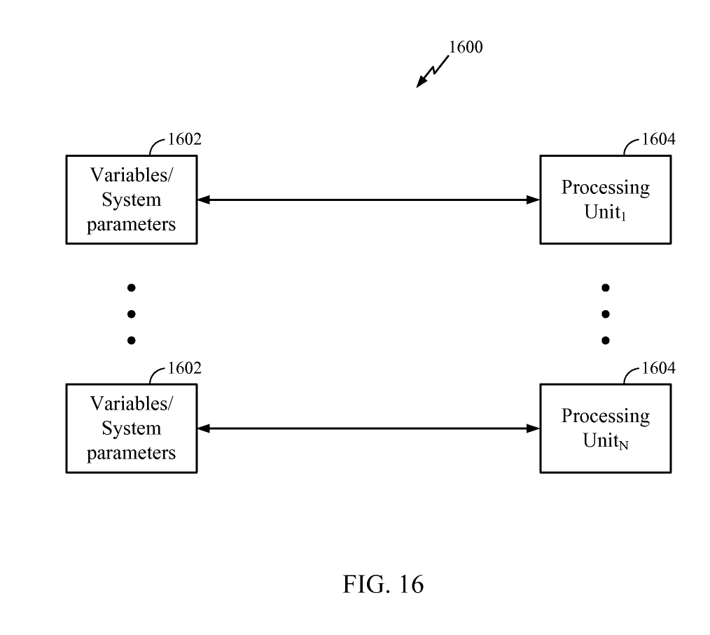

FIG. 16 illustrates an example block diagram 1600 of components for operating an artificial nervous system based on distributed weight memories 1602 and distributed processing units (neural processors) 1604 in accordance with certain aspects of the present disclosure. As illustrated in FIG. 16, one memory bank 1602 may be directly interfaced with one processing unit 1604 of a computational network (neural network), wherein that memory bank 1602 may store variables (neural signals), synaptic weights, and/or system parameters associated with that processing unit (neural processor) 1604. In an aspect of the present disclosure, the processing unit(s) 1604 may be configured to record spike times for a first artificial neuron, to record spike times for a second artificial neuron coupled to the first artificial neuron via a synapse, to process spikes for the second artificial neuron according to a window based at least in part on the spike times for the first artificial neuron, and to update a parameter of the synapse based on the processing.

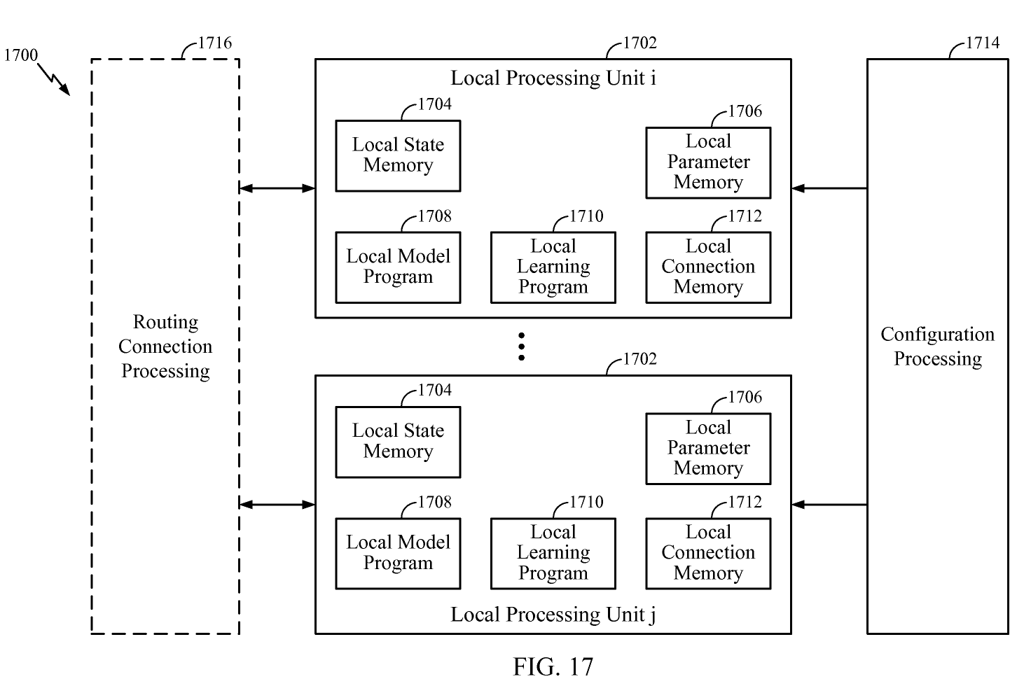

FIG. 17 illustrates an example implementation of a neural network 1700 in accordance with certain aspects of the present disclosure. As illustrated in FIG. 17, the neural network 1700 may comprise a plurality of local processing units 1702 that may perform various operations of methods described above. Each processing unit 1702 may comprise a local state memory 1704 and a local parameter memory 1706 that store parameters of the neural network. In addition, the processing unit 1702 may comprise a memory 1708 with a local (neuron) model program, a memory 1710 with a local learning program, and a local connection memory 1712. Furthermore, as illustrated in FIG. 17, each local processing unit 1702 may be interfaced with a unit 1714 for configuration processing that may provide configuration for local memories of the local processing unit, and with routing connection processing elements 1716 that provide routing between the local processing units 1702.

According to certain aspects of the present disclosure, each local processing unit 1702 may be configured to determine parameters of the neural network based upon desired one or more functional features of the neural network, and develop the one or more functional features towards the desired functional features as the determined parameters are further adapted, tuned and updated.

### CONCLUSION

Certain aspects of the present disclosure use a FIFO buffer of the N most recent spikes at each artificial neuron and then process the STDP updates based on a delay after either the pre-synaptic or post-synaptic spikes. One advantage over the triplet rule is that up to N post-synaptic spikes can be processed for LTP for each pre-synaptic spike, which allows learning for certain neural models for which the triplet rule failed.

Certain aspects of the present disclosure keep a count variable in each neuron and mark the count in each synapse. The STDP LTP update then uses the count value times the asymptotic LTP value+k STDP LTP function lookups.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various operations may be performed by one or more of the various processors shown in FIGS. 14-17. Generally, where there are operations illustrated in figures, those operations may have corresponding counterpart means-plus-function components with similar numbering. For example, operations 1100 illustrated in FIG. 11 correspond to means 1100A illustrated in FIG. 11A.

For example, means for displaying may comprise a display (e.g., a monitor, flat screen, touch screen, and the like), a printer, or any other suitable means for outputting data for visual depiction (e.g., a table, chart, or graph). Means for processing, means for recording, means for calculating, means for computing, means for updating, or means for determining may comprise a processing system, which may include one or more processors or processing units. Means for storing may comprise a memory or any other suitable storage device (e.g., RAM), which may be accessed by the processing system.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for operating an artificial nervous system, comprising:
recording spike times for a first artificial neuron;
recording spike times for a second artificial neuron coupled to the first artificial neuron via a synapse, wherein recording the spike times for the second artificial neuron comprises keeping the spike times for the second artificial neuron that occur within an amount of time;
processing spikes for the second artificial neuron according to a window based at least in part on the spike times for the first artificial neuron; and
updating a parameter of the synapse based on the processing.

2. The method of claim 1, wherein recording the spike times for the second artificial neuron further comprises ignoring or discarding any spike times for the second artificial neuron in the window, but outside the amount of time.

3. The method of claim 1, wherein the first artificial neuron comprises a presynaptic neuron and wherein the second artificial neuron comprises a postsynaptic neuron, relative to the synapse.

4. The method of claim 1, wherein the window begins at a first spike time for the first artificial neuron and ends at a second spike time for the first artificial neuron.

5. The method of claim 4, wherein the first and second spike times are for two consecutive spikes for the first artificial neuron.

6. The method of claim 1, wherein the parameter of the synapse comprises a weight of the synapse.

7. The method of claim 1, wherein the parameter of the synapse comprises a delay of the synapse.

8. The method of claim 1, wherein the parameter of the synapse comprises at least one of a resource value, a neurotransmitter characteristic, or a sum-delta weight of the synapse.

9. The method of claim 1, wherein the processing comprises determining a set of the spikes for the second artificial neuron in the window and in the amount of time, based at least in part on a predetermined number of spikes.

10. The method of claim 9, wherein determining the set of the spikes for the second artificial neuron comprises at least one of selecting initial spikes for the second artificial neuron in the window and in the amount of time or randomly selecting the spikes for the second artificial neuron in the window and in the amount of time, according to the predetermined number of spikes.

11. The method of claim 9, wherein the predetermined number of spikes is 3.

12. The method of claim 9, wherein the processing further comprises:
counting a number of the spikes for the second artificial neuron in the window; and
determining first weight change values associated with the recorded spike times for the set of the spikes, based at least in part on a first portion of a spike-timing dependent plasticity (STDP) equation or lookup table.

13. The method of claim 12, wherein the processing further comprises determining second weight change values associated with the spikes for the second artificial neuron in the window that are not in the set of the spikes, based at least in part on a second portion of the STDP equation or lookup table.

14. The method of claim 13, wherein the STDP equation or lookup table is based at least in part on a function having an asymptotic value for positive times above a threshold time, wherein the first portion is below the threshold time, and wherein the second portion is above the threshold time.

15. The method of claim 14, wherein the asymptotic value is less than or equal to 0.

16. The method of claim 14, wherein the second weight change values equal the asymptotic value.

17. The method of claim 14, wherein updating the parameter of the synapse comprises:
effectively multiplying the asymptotic value by a difference between the counted number of the spikes in the window and a number of elements in the set of the spikes; and
summing a result of the multiplication, the first weight change values, and a previous weight of the synapse to generate an updated weight of the synapse.

18. A method for operating an artificial nervous system, comprising:
recording spike times for a first artificial neuron;
recording spike times for a second artificial neuron coupled to the first artificial neuron via a synapse, wherein recording the spike times for the second artificial neuron comprises keeping up to a predetermined number of the spike times for the second artificial neuron
processing spikes for the second artificial neuron according to a window based at least in part on the spike times for the first artificial neuron; and
updating a parameter of the synapse based on the processing.

19. The method of claim 18, wherein recording the spike times for the second artificial neuron further comprises ignoring or discarding any spike times for the second artificial neuron above the predetermined number.

20. The method of claim 18, wherein keeping up to the predetermined number comprises keeping up to the predetermined number of the spike times for the second artificial neuron in a buffer.

21. The method of claim 18, wherein keeping up to the predetermined number of the spike times comprises keeping up to the predetermined number of the most recent spike times for the second artificial neuron and wherein ignoring or discarding spike times above the predetermined number comprises ignoring or discarding older spike times when newer spike times are recorded.

22. The method of claim 18, wherein the predetermined number of the spike times is between 6 and 20 inclusive.

23. The method of claim 18, wherein recording the spike times for the second artificial neuron further comprises:
keeping up to the predetermined number of the spike times for the second artificial neuron that occur within a predetermined amount of time; and
ignoring or discarding any spike times for the second artificial neuron outside the predetermined amount of time or above the predetermined number.

24. The method of claim 23, wherein the predetermined amount of time is between 2 and 4 seconds inclusive.

25. The method of claim 18, wherein the window begins at a first minimum time between a delay added to a first spike time for the first artificial neuron and a synaptic delay added to a second spike time for the first artificial neuron, wherein the second spike time is subsequent to the first spike time.

26. The method of claim 25, wherein the first and second spike times are for two consecutive spikes for the first artificial neuron.

27. The method of claim 25, wherein updating the parameter of the synapse occurs at the delay added to the second spike time for the first artificial neuron.

28. The method of claim 25, wherein the delay is greater than a non-asymptotic portion of a spike-timing dependent plasticity (STDP) function.

29. The method of claim 25, wherein the window ends at a second minimum time between the delay minus a step size for the artificial nervous system added to the second spike time for the first artificial neuron and the synaptic delay minus the step size added to a third spike time for the first artificial neuron and wherein the third spike time is subsequent to the second spike time.

30. The method of claim 29, wherein the second and third spike times are for two consecutive spikes for the first artificial neuron.

31. The method of claim 25, wherein the parameter of the synapse comprises a weight of the synapse and wherein the processing comprises determining first weight change values associated with the recorded spike times for the second artificial neuron within the window and greater than or equal to the second spike time that have been kept, based at least in part on a first portion of a spike-timing dependent plasticity (STDP) equation or lookup table.

32. The method of claim 31, wherein the processing further comprises determining second weight change values associated with the recorded spike times for the second artificial neuron within the window and less than the second spike time that have been kept, based at least in part on a second portion of the STDP equation or lookup table.

33. The method of claim 32, wherein the STDP equation or lookup table is based at least in part on a function having an asymptotic value for positive times above a threshold time, wherein the first portion is below the threshold time, and wherein the second portion is above the threshold time.

34. The method of claim 33, wherein the asymptotic value is less than or equal to 0.

35. The method of claim 33, wherein the second weight change values equal the asymptotic value.

36. The method of claim 32, wherein the processing further comprises determining a third weight change value associated with one of the recorded spike times for the second artificial neuron in the window that has been kept, just prior to the second spike time for the first artificial neuron, based at least in part on a third portion of the STDP equation or lookup table.

37. The method of claim 36, wherein updating the parameter of the synapse comprises:
effectively multiplying the second weight change values by a number of the recorded spike times of the second artificial neuron in the window and less than the second spike time that have been kept; and
summing a result of the multiplication, the first weight change values, the third weight change value, and a previous weight of the synapse to generate an updated weight of the synapse.

38. The method of claim 18, wherein ignoring or discarding spike times above the predetermined number comprises randomly ignoring or discarding an older spike time when a new spike time arrives that would make the kept number of spike times greater than the predetermined number.

39. The method of claim 18, wherein the parameter of the synapse comprises a weight of the synapse.

40. The method of claim 18, wherein the parameter of the synapse comprises a delay of the synapse.

41. The method of claim 18, wherein the parameter of the synapse comprises at least one of a resource value, a neurotransmitter characteristic, or a sum-delta weight of the synapse.

42. The method of claim 18, wherein the first artificial neuron comprises a presynaptic neuron and wherein the second artificial neuron comprises a postsynaptic neuron, relative to the synapse.

43. The method of claim 18, wherein the artificial nervous system is configured to operate according to a discrete time increment and wherein at least one of the recording or the processing is based on a resolution finer than the discrete time increment.

44. An apparatus for operating an artificial nervous system, comprising:
a processing system configured to:
record spike times for a first artificial neuron;
record spike times for a second artificial neuron coupled to the first artificial neuron via a synapse, wherein recording the spike times for the second artificial neuron comprises keeping the spike times for the second artificial neuron that occur within an amount of time;
process spikes for the second artificial neuron according to a window based at least in part on the spike times for the first artificial neuron; and
update a parameter of the synapse based on the processing; and
a memory coupled to the processing system.

45. The apparatus of claim 44, wherein the processing system is further configured to record the spike times for the second artificial neuron by ignoring or discarding any spike times for the second artificial neuron in the window, but outside the amount of time.

46. The apparatus of claim 44, wherein the processing system is configured to process the spikes for the second artificial neuron by determining a set of the spikes for the second artificial neuron in the window and in the amount of time, based at least in part on a predetermined number of spikes.

47. The apparatus of claim 46, wherein the processing system is further configured to process the spikes for the second artificial neuron by:
counting a number of the spikes for the second artificial neuron in the window; and
determining first weight change values associated with the recorded spike times for the set of the spikes, based at least in part on a first portion of a spike-timing dependent plasticity (STDP) equation or lookup table.

48. An apparatus for operating an artificial nervous system, comprising:
a processing system configured to:
record spike times for a first artificial neuron;
record spike times for a second artificial neuron coupled to the first artificial neuron via a synapse, wherein recording the spike times for the second artificial neuron comprises keeping up to a predetermined number of the spike times for the second artificial neuron;
process spikes for the second artificial neuron according to a window based at least in part on the spike times for the first artificial neuron; and
update a parameter of the synapse based on the processing; and
a memory coupled to the processing system.

49. The apparatus of claim 48, wherein the processing system is further configured to record the spike times for the second artificial neuron by:
keeping up to the predetermined number of the spike times for the second artificial neuron that occur within a predetermined amount of time; and
ignoring or discarding any spike times for the second artificial neuron outside the predetermined amount of time or above the predetermined number.

50. The apparatus of claim 48, wherein the window begins at a first minimum time between a delay added to a first spike time for the first artificial neuron and a synaptic delay added to a second spike time for the first artificial neuron, wherein the second spike time is subsequent to the first spike time.

51. The apparatus of claim 50, wherein the parameter of the synapse comprises a weight of the synapse and wherein the processing system is configured to process the spikes for the second artificial neuron by determining first weight change values associated with the recorded spike times for the second artificial neuron within the window and greater than or equal to the second spike time that have been kept, based at least in part on a first portion of a spike-timing dependent plasticity (STDP) equation or lookup table.

52. An apparatus for operating an artificial nervous system, comprising:
means for recording spike times for a first artificial neuron;
means for recording spike times for a second artificial neuron coupled to the first artificial neuron via a synapse, wherein the means for recording the spike times for the second artificial neuron is configured to keep the spike times for the second artificial neuron that occur within an amount of time;
means for processing spikes for the second artificial neuron according to a window based at least in part on the spike times for the first artificial neuron; and
means for updating a parameter of the synapse based on the processing.

53. An apparatus for operating an artificial nervous system, comprising:
means for recording spike times for a first artificial neuron;
means for recording spike times for a second artificial neuron coupled to the first artificial neuron via a synapse, wherein the means for recording the spike times for the second artificial neuron is configured to keep up to a predetermined number of the spike times for the second artificial neuron;
means for processing spikes for the second artificial neuron according to a window based at least in part on the spike times for the first artificial neuron; and
means for updating a parameter of the synapse based on the processing.

54. A computer program product for operating an artificial nervous system, comprising a computer-readable medium having instructions executable to:
record spike times for a first artificial neuron;
record spike times for a second artificial neuron coupled to the first artificial neuron via a synapse, wherein recording the spike times for the second artificial neuron comprises keeping the spike times for the second artificial neuron that occur within an amount of time;
process spikes for the second artificial neuron according to a window based at least in part on the spike times for the first artificial neuron; and
update a parameter of the synapse based on the processing.

55. A computer program product for operating an artificial nervous system, comprising a computer-readable medium having instructions executable to:
record spike times for a first artificial neuron;
record spike times for a second artificial neuron coupled to the first artificial neuron via a synapse, wherein recording the spike times for the second artificial neuron comprises keeping up to a predetermined number of the spike times for the second artificial neuron;
process spikes for the second artificial neuron according to a window based at least in part on the spike times for the first artificial neuron; and
update a parameter of the synapse based on the processing.
